(19) United States
(12) Patent Application Publication
(10) Pub. No.: US 2013/0321117 A1
(43) Pub. Date: Dec. 5, 2013

(54) PLANAR TRANSFORMER AND METHOD OF MANUFACTURING THE SAME

(71) Applicant: Samsung Electro-Mechanics Co., Ltd., Suwon (KR)

(72) Inventors: Geun Young Park, Suwon (KR); Sang Joon Seo, Suwon (KR); Jin An Jung, Suwon (KR); Kwang Seung Cho, Suwon (KR); Deuk Hoon Kim, Incheon (KR)

(21) Appl. No.: 13/929,666

(22) Filed: Jun. 27, 2013

(30) Foreign Application Priority Data
Apr. 5, 2010 (KR) 1020100031027

(51) Int. Cl. H01F 27/28; H01F 41/34

(52) U.S. Cl. CPC H01F 27/2804; H01F 41/34
USPC 336/200; 29/602.1

(57) ABSTRACT

A planar transformer for preventing resin being coated from being separated from a conductor during the manufacturing of a transformer by forming a dummy pattern on a board includes: a core part having a pair of cores electromagnetically coupled to each other; a board part having a plurality of boards disposed between the pair of cores and stacked upon one another; a pattern part having a power transmission pattern provided on at least one board of the plurality of boards of the board part and transmitting power being input, and a dummy pattern provided on the same board having the power transmission pattern thereon and separated from the power transmission pattern by a predetermined interval; and a resin part being coated over the at least one board of the plurality of boards, the at least one board having the pattern part thereon.

### CROSS-REFERENCE TO RELATED APPLICATIONS

This application claims the priority of Korean Patent Application No. 10-2010-0031027 filed on Apr. 5, 2010, in the Korean Intellectual Property Office, the disclosure of which is incorporated herein by reference.

### BACKGROUND OF THE INVENTION

1. Field of the Invention

The present invention relates to a planar transformer and a method of manufacturing the same, and more particularly, to a planar transformer and a method of manufacturing the same that can prevent resin, being coated, from being separated from a conductor during the manufacturing of a transformer by forming a dummy pattern on a board.

2. Description of the Related Art

With the trend toward the size reduction of various kinds of electronic apparatuses, there is also a need for the size reduction of power supply units.

Basically, the size reduction of power supplies can be achieved by driving power terminals with a high frequency. However, size reduction may be inhibited by magnetic devices and capacitors.

The recent development of capacitors having small heights or small diameters, which are appropriate for slim power supply units, has accelerated a further size reduction of a wide array of electronic apparatuses.

Generally, in the case of transformers, which are representative magnetic devices, a size reduction can be achieved by forming the windings of magnetic devices by stacking multilayered boards having circuits printed thereon.

Planar transformers have patterns, formed on respective boards, which can form current paths instead of using the coils of a general transformer. The above-described boards are stacked upon one another to thereby form a single planar transformer. Insulating resin is injected between the respective boards and then flows between the patterns to thereby increase insulating properties.

However, while the boards are being stacked upon one another, the resins being injected may detach between patterns, where insulation is required, which may lead to a deterioration in insulating performance.

### SUMMARY OF THE INVENTION

An aspect of the present invention provides a planar transformer and a method of manufacturing the same that can prevent resin being coated during the manufacturing of a transformer from being separated from a conductor by forming a dummy pattern on a board.

According to an aspect of the present invention, there is provided a planar transformer including: a core part having a pair of cores electromagnetically coupled to each other; a board part having a plurality of boards disposed between the pair of cores and stacked upon one another; a pattern part having a power transmission pattern provided on at least one board of the plurality of boards of the board part and transmitting power being input, and a dummy pattern provided on the same board having the power transmission pattern thereon and separated from the power transmission pattern by a predetermined interval; and a resin part being coated over the at least one board of the plurality of boards, the at least one board having the pattern part thereon.

At least one via hole, electrically connected to the power transmission pattern, maybe provided in the at least one board.

The dummy pattern may be separated from the power transmission pattern and be adjacent to the at least one via hole.

The dummy pattern may be provided on a remaining region of the at least one board, on which the power transmission pattern and the at least one via hole are not provided.

Each of the plurality of boards may have a through hole into which the core part is inserted.

The power transmission pattern may be provided along a circumference of the board on the basis of the through hole of the at least one board.

The power transmission pattern may be formed in a spiral shape along a circumference of the board on the basis of the through hole.

The board part may include a first board and a second board, the power transmission pattern may include a primary power transmission pattern, provided on the first board, and a secondary power transmission pattern, provided on the second board, and the primary power transmission pattern and the secondary power transmission pattern may form a predetermined turns ratio therebetween.

The board part may include a first cover board stacked upon the first board; and a second cover board stacked under the second board.

According to another aspect of the present invention, there is provided a method of manufacturing a planar transformer, the method including: preparing a plurality of boards; forming a power transmission pattern transmitting power being applied to at least one board of the plurality of boards and a dummy pattern separated from the power transmission pattern by a predetermined interval; coating the at least one board with insulating resin; and stacking the plurality of boards one upon another.

The forming of the power transmission pattern may include forming at least one via hole in the at least one board, the at least one via hole electrically connected to the power transmission pattern.

In the forming of the dummy pattern, the dummy pattern may be separated from the power transmission pattern and is adjacent to the at least one via hole.

In the forming of the dummy pattern, the dummy pattern may be formed on a remaining region of the at least one board, on which the power transmission pattern and the at least one via hole are not formed.

The preparing of the plurality of boards may include forming a through hole in each of the plurality of boards, the through hole into which the core part is inserted.

The forming of the power transmission pattern may include forming the power transmission pattern along a circumference of the board on the basis of the through hole of the at least one board.

The forming of the power transmission pattern may include forming the power transmission pattern in a spiral shape along a circumference of the board on the basis of the through hole.

The preparing of the boards may include preparing first and second boards being stacked upon one another, the forming of the power transmission pattern may include forming a primary power transmission pattern formed on the first board and a secondary power transmission pattern formed on the second board, and the primary power transmission pattern and the secondary power transmission pattern form a predetermined turns ratio.

The preparing of the boards further may include forming:

a first cover board stacked upon the first board; and a second cover board staked under the second board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded perspective view illustrating a transformer according to an exemplary embodiment of the present invention;

FIG. 2 is a schematic side view illustrating a transformer according to an exemplary embodiment of the present invention;

FIGS. 3A through 3D are configuration views illustrating various embodiments of a dummy pattern formed on aboard that is used in a transformer according to an exemplary embodiment of the present invention; and

FIG. 4 is a flowchart illustrating a method of manufacturing a planar transformer according to an exemplary embodiment of the present invention.

### DETAILED DESCRIPTION OF THE PREFERRED EMBODIMENT

Exemplary embodiments of the present invention will now be described in detail with reference to the accompanying drawings.

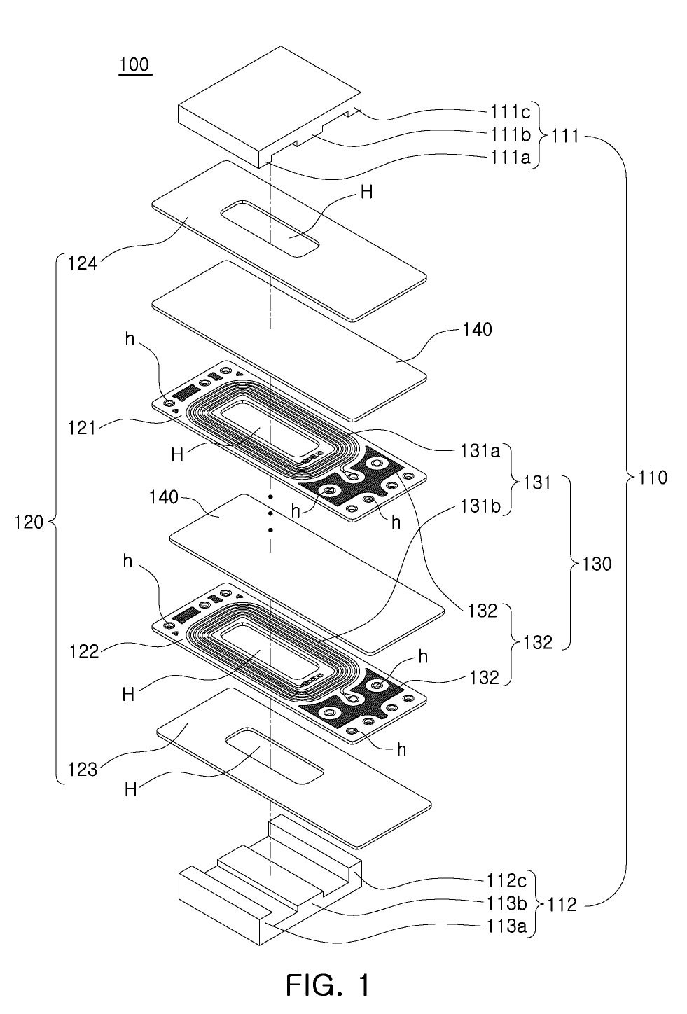

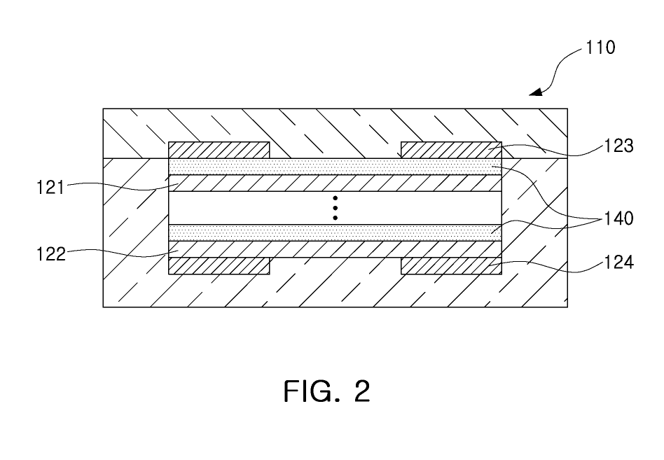

FIG. 1 is a schematic exploded perspective view illustrating a transformer according to an exemplary embodiment of the invention. FIG. 2 is a schematic side view illustrating a transformer according to an exemplary embodiment of the invention.

Referring to FIG. 1, a planar transformer 100 according to this embodiment may include a core part 110, a board part 120, and a pattern part 130.

The core part 110 may include a pair of cores 111 and 112 that are electromagnetically coupled to each other.

The pair of cores 111 and 112 may include respective legs that are electromagnetically coupled to each other.

As described in FIG. 1, the pair of cores 111 and 112 may be EE cores. However, the present invention is not limited thereto, and the pair of cores 111 and 112 may be EI cores, UU cores, UI cores, and the like.

As described in FIG. 1, while the core 111 may include first, second, and third legs 111a, 111b, and 111c, the core 112 may include 112a, 112b, and 112c, so that the pair of cores 111 and 112 may be electromagnetically coupled to each other by coupling between the first legs 111a and 112a, the second legs 111b and 112b and the third legs 111c and 112c.

The board part 120 may be provided between the pair of cores 111 and 112.

The board part 120 may include a plurality of boards.

As described in FIG. 1, the board part 120 may include at least one board or a plurality of boards. The plurality of boards may be stacked upon one another and have through holes H therein, into which the legs of the pair of cores 111 and 112 are inserted.

The plurality of boards may be configured as printed circuit boards (PCBs) that have circuits printed on the surfaces thereof.

The pattern part 130 may be individually formed on the plurality of boards.

The pattern part 130 may be composed of a conductor through which currents flow. The pattern part 130 may include a power transmission pattern 131 transmitting power being input and a dummy pattern 132 with no electrical connection.

The power transmission pattern 131 may serve as coils forming a turns ratio between primary and secondary windings of a general transformer.

For example, when the board part 120 has a first board 121 and a second board 122, a primary power transmission pattern 131a is formed on the first board 121, and a secondary power transmission pattern 131b is formed on the second board 122, so that the primary power transmission pattern 131a and the secondary power transmission pattern 131b serve as a primary winding and a secondary winding of a general transformer, thereby forming a predetermined turns ratio therebetween.

To this end, the primary power transmission pattern 131a and the secondary power transmission pattern 131b may be formed around the circumferences of the first and second boards 121 and 122, respectively, and may be formed in a spiral shape on the basis of the through holes H in order to obtain a desired turns ratio.

In the case that a high turns ratio is required, the primary power transmission pattern 131a and the secondary power transmission pattern 131b may be formed on the respective plurality of boards, and the primary power transmission pattern 131a or the secondary power transmission pattern 131b may be electrically connected with each other through the via holes h.

The plurality of boards may include a first cover board 123 to be stacked upon the first board 121 and a second cover board 124 to be stacked under the second board 122. As described above, the plurality of boards are stacked upon one another to thereby form a single transformer. At this time, in order to increase the insulating performance of the transformer, the boards may be coated with insulating resin to thereby form the resin part 140.

The resin part 140 may be formed on the board on which the power transmission pattern 131 is formed.

When the board, on which the resin part 140 is formed, is stacked, the insulating resin of the resin part 140 may be separated from the power transmission pattern 131 and be leaked through the via holes h. That is, the power transmission pattern 131 is formed by forming a copper plate on the board and etching the copper plate, leaving necessary portions thereof remaining. The insulating resin may be leaked through the via holes h along the remaining region of the board, on which the copper plate is not formed.

Therefore, the copper plate except for the power transmission pattern 131 is left on the remaining region of the board to form the dummy pattern 132, thereby reducing the remaining region where the insulating resin may leak by preventing the separation of the insulating resin.

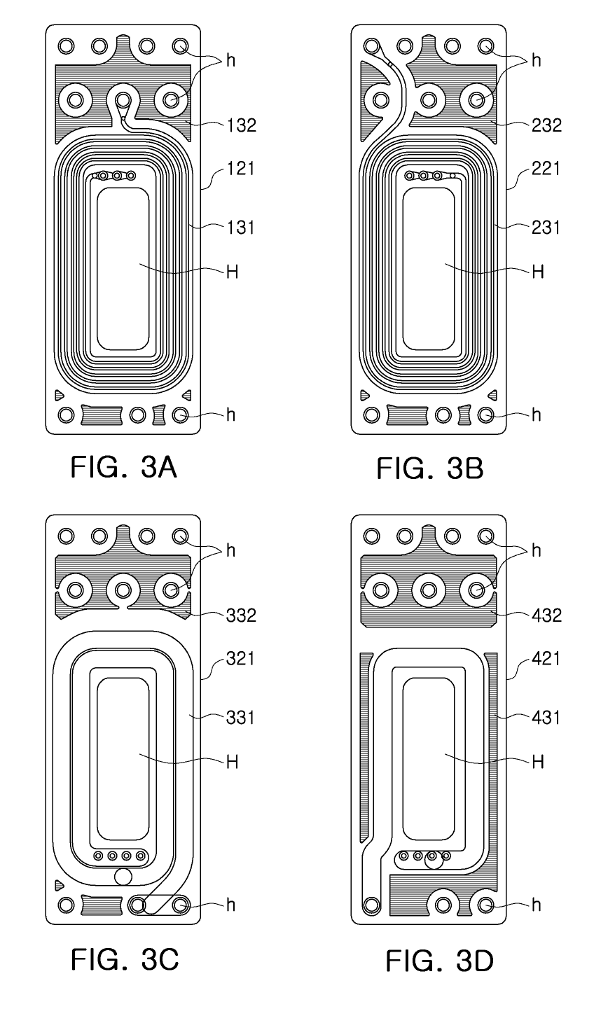

FIGS. 3A through 3D are views illustrating various embodiments of a pattern part formed on a board being used in a transformer according to an exemplary embodiment of the invention.

As described above, the dummy pattern 132 may be formed on the first board 121, on which the power transmission pattern 131 is formed, thereby preventing the separation of the insulating resin through via holes h.

As shown in FIG. 3A, when a plurality of via holes h are formed in the first board 121 and the power transmission pattern 131 is electrically connected to the via holes h, the dummy pattern 132 may be separated from the power transmission pattern 131 by a predetermined interval and be adjacent to the via holes h.

As shown in FIG. 3B, when a power transmission pattern 231 is electrically connected to a via hole, disposed on the outermost edge, among a plurality of via holes h in the board 221, a dummy pattern 232 may also be separated from the power transmission pattern 231 by a predetermined interval and be adjacent to the via holes h.

As shown in FIG. 3C, when a plurality of via holes h are formed in both sides of a board 321, if a power transmission pattern 331 is electrically connected to the via holes h formed in one side of the board 321, a dummy pattern 332 maybe adjacent to the via holes h formed in the other side of the board 321.

In the same manner, as shown in FIG. 3D, when a plurality of via holes h are formed in both sides of a board 421, if one side of a power transmission pattern 431 is electrically connected to the via holes h, a dummy pattern 432 maybe separated from the power transmission pattern 431 by a predetermined distance and be adjacent to the via holes h formed in both sides of the board 421. The dummy pattern 432 may also be formed on a remaining region of the board, on which the power transmission pattern 431 is not formed, without being adjacent to the via holes h.

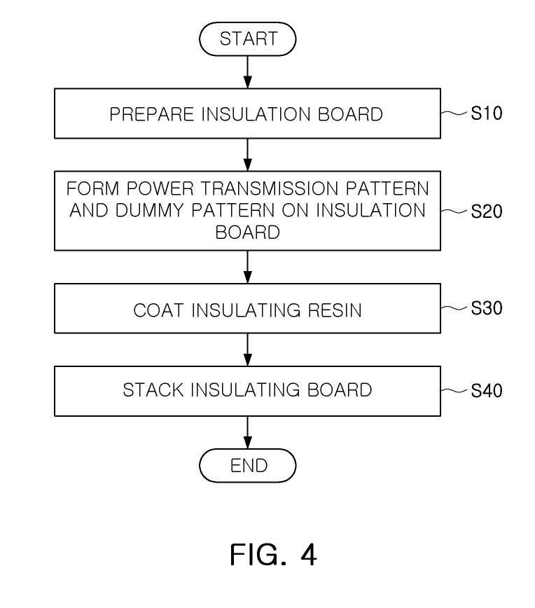

FIG. 4 is a flowchart illustrating a method of manufacturing a planar transformer according to an exemplary embodiment of the invention.

According to a method of manufacturing a planar transformer, a plurality of boards are prepared in operation S10. As described above, the plurality of boards may include the first and second boards and the first and second cover boards as described above.

At least one of the plurality of boards or the first and second boards are coated with a copper plate, which is then removed by etching to thereby form the power transmission pattern and the dummy pattern in operation S20. The copper plate of the board that does not correspond to the power transmission pattern may not be etched to thereby form the dummy pattern.

The board on which the power transmission pattern and the dummy pattern are formed may be coated with the insulating resin in operation S30.

The plurality of boards are stacked upon one another, and the cores are then coupled thereto, thereby forming a single planar transformer in operation S40.

As described above, since dummy patterns are individually formed on boards, even when the boards are coated with insulating resin and are then stacked upon one another, the separation of the insulating resin is prevented to thereby improve the insulating performance of the transformer.

As set forth above, according to exemplary embodiments of the invention, the separation of resin to be coated when a transformer is manufactured is prevented by forming a dummy pattern on a board, thereby improving the insulating performance of the transformer.

While the present invention has been shown and described in connection with the exemplary embodiments, it will be apparent to those skilled in the art that modifications and variations can be made without departing from the spirit and scope of the invention as defined by the appended claims.

1-18. (canceled)

19. A planar transformer, comprising:
a first core and a second core configured to be electromagnetically coupled to each other;
a first board and a second board between the first core and the second core, wherein
the first board includes
a primary power transmission pattern,
a first dummy pattern, and
at least one first via hole, and
the second board includes
a secondary power transmission pattern,
a second dummy pattern, and
at least one second via hole,
the primary power transmission pattern and the secondary power transmission pattern are configured to be electrically connected to each other through the at least one first via hole and the at least one second via hole,
the primary power transmission pattern, the secondary power transmission pattern, the first dummy pattern, and the second dummy pattern comprise the same material;
a first resin layer comprising an insulating resin coating on the first board and covering both the primary power transmission pattern and the first dummy pattern; and
a second resin layer comprising an insulating resin coating on the second board and covering both the secondary power transmission pattern and the second dummy pattern.

20. The planar transformer according to claim 19, wherein
an area of the primary power transmission pattern is larger than an area of the first dummy pattern, and
an area of the secondary power transmission pattern is larger than an area of the second dummy pattern.

21. The planar transformer according to claim 19, wherein
the first dummy pattern is on at least one peripheral side of the first board, and
the second dummy pattern is on at least one peripheral side of the second board.

22. The planar transformer according to claim 19, wherein
the first dummy pattern is adjacent to the at least one first via hole, and
the second dummy pattern is adjacent to the at least one second via hole.

23. The planar transformer according to claim 19, wherein
the at least one first via hole includes a first first-via-hole and a second first-via-hole,
the at least one second via hole includes a first second-via-hole and a second second-via-hole,
the primary power transmission pattern and the secondary power transmission pattern are configured to be electrically connected to each other through the first first-via-hole and the first second-via-hole,
the first dummy pattern is in proximity to the second first-via-hole, and
the second dummy pattern is in proximity to the second second-via-hole.

24. The planar transformer according to claim 19, wherein
the at least one first via hole includes a plurality of first via holes,
the at least one second via hole includes a plurality of second via holes,
the primary power transmission pattern and the secondary power transmission pattern are configured to be electrically connected to each other through a first first-via-hole among the plurality of first via holes and a first second-via-hole among the plurality of second via holes,
the first dummy pattern is proximity to the first via holes other than the first first-via-hole, and
the second dummy pattern is in proximity to the second via holes other than the first second-via-hole.

25. A method of manufacturing a planar transformer that includes a first core and a second core configured to be electromagnetically coupled to each other and a first board and a second board between the first core and the second core, the method comprising:
forming a primary power transmission patter and a first dummy pattern on the first board;
forming at least one first via hole on the first board;
forming a secondary power transmission pattern and a second dummy pattern in the second board;
forming at least one second via hole on the second board;
coating the first board with an insulating resin so as to cover both the primary power transmission pattern and the first dummy pattern; and
coating the second board with the insulating resin so as to cover both the secondary power transmission pattern and the second dummy pattern, wherein
the primary power transmission pattern and the secondary power transmission pattern are configured to be electrically connected to each other through the at least one first via hole and the at least one second via hole, and
the primary power transmission pattern, the secondary power transmission pattern, the first dummy pattern, and the second dummy pattern comprise the same material.

26. The method according to claim 25, wherein
a size of the primary power transmission pattern is larger than a size of the first dummy pattern, and
a size of the secondary power transmission pattern is larger than a size of the second dummy pattern.

27. The method according to claim 25, wherein
the first dummy pattern is on at least one peripheral side of the first board, and
the second dummy pattern is on at least one peripheral side of the second board.

28. The method according to claim 25, wherein
the first dummy pattern is adjacent to the at least one first via hole, and
the second dummy pattern is adjacent to the at least one second via hole.

29. The method according to claim 25, wherein
the at least one first via hole includes a first first-via-hole and a second first-via-hole,
the at least one second via hole includes a first second-via-hole and a second second-via-hole,
the primary power transmission pattern and the secondary power transmission pattern are configured to be electrically connected to each other through the first first-via-hole and the first second-via-hole,
the first dummy pattern is in proximity to the second first-via-hole, and
the second dummy pattern is in proximity to the second second-via-hole.

30. The method according to claim 25, wherein
the at least one first via hole includes a plurality of first via holes,
the at least one second via hole includes a plurality of second via holes,
the primary power transmission pattern and the secondary power transmission pattern are configured to be electrically connected to each other through a first first-via-hole among the plurality of first via holes and a first second-via-hole among the plurality of second via holes,
the first dummy pattern is proximity to the first via holes other than the first first-via-hole, and
the second dummy pattern is in proximity to the second via holes other than the first second-via-hole.
